(19) United States
(12) Patent Application Publication
(10) Pub. No.: US 2016/0231901 A1
(43) Pub. Date: Aug. 11, 2016

(54) COMPUTER IMPLEMENTED METHOD FOR ASSESSING IDEAS

(71) Applicant: Umm Al-Qura University, Makkah (SA)

(72) Inventor: Abdulrahman Ahmed Hariri, Jeddah (SA)

(73) Assignee: Umm Al-Qura University

(21) Appl. No.: 14/619,481

(22) Filed: Feb. 11, 2015

(51) Int. Cl. G06F 3/0484

(52) U.S. Cl. CPC G06F 3/04842; G06F 3/04847

(57) ABSTRACT

A computer-implemented method for displaying, communicating, collaborating and assessing an idea for a complete understanding of the idea. A method includes the steps of providing a computer and monitor for displaying a number of interactive screens including a plurality of interactive blocks or chain of blocks and including data input device for displaying an idea on a plurality of computers.

The next step calls for displaying on the computer an idea and a plurality of interactive screens wherein each screen includes a plurality of interactive blocks or chains of blocks. A value added chain includes blocks for outcomes, obstacles and beneficiaries.

A knowledge chain includes blocks for the known, the unknown and knowledge gaps.

### FIELD OF THE INVENTION

This invention relates to a computer implemented method for assessing ideas and more particularly to a computer implemented method for displaying, communicating, collaborating, and assessing an idea and its details for a more complete understanding of an implication of the idea. The invention also relates to establishing a network of linked computers for a plurality of users to develop a better understanding of an invention.

### BACKGROUND OF THE INVENTION

In the past five or so years computer implemented methods and systems for evaluating ideas have been developed as for example, defined in a U.S. Pat. No. 7,536,310 of Klausnitzer. As disclosed therein, a method for managing an idea management system and providing the system as a service to a third party. By this configuration, ideas originated by employees of the customer can flow into the products or services of the provider of the idea management system. The invention can increase the relationship between the service provider and the customer, therefore the invention is regarded to be an aspect of CRM (Customer Relationship Management). If the customer and the service provider use a common software platform, a common middleware platform or a common information system (e.g. ERP-system; Enterprise Resource Planning) the CRM aspect of the invention will be additionally strengthened. Furthermore the incoming ideas are not only of interest for the service provider to get into its own products and services, but also could be retailed to third parties.

A more recent U.S. Pat. No. 8,161,087 of Latzina discloses a Displaying and Manipulating Virtual Objects on Virtual Surfaces. The patent discloses a computerized method of providing an interactive virtual surface to display virtual objects. The method comprises providing the virtual surface via a graphical user interface on a display screen, wherein the virtual surface displays at least one axis and a plurality of virtual objects. The method monitors positioning (including re-positioning) of each of the plurality of virtual objects by a user on the virtual surface relative to the axis. Thereafter, virtual object association data may be stored in a database identifying an association between each of the virtual objects and at least one attribute based on the positioning.

Finally, a U.S. Pat. No. 8,341,068 of Koen et al. discloses a Method and Apparatus for Generating and Evaluating Ideas in an Organization. The invention discloses a method and apparatus for generating and evaluating ideas within an organization through an idea market. It includes an automatic price-setting mechanism that modifies the share-price at the same instant that a trade is made, yet without the assistance of a market maker or a queue of orders. The instant price-setting is achieved by assuming a pre-defined relationship between the quantity of shares in the order and the average share price for that order. This relationship is the price-quantity function. The invention also includes a mechanism of weighted parameters to modify the share-price in addition to pure supply and demand. The parameters can be adjusted over time in a neural network to optimize the relationship between the share price and the prediction of the actual idea value.

Notwithstanding the above, it is presently believed that there is a need and a potential commercial market for a computer implemented method and apparatus for assessing ideas in accordance with the present invention. There should be a demand and a potential commercial market for such methods and systems because the methods and systems provide an approach for displaying, communicating, collaborating, and evaluating an idea and its details for a more complete understanding of the idea.

### BRIEF SUMMARY OF THE INVENTION

In essence, the present invention comprises or consists of a computer implemented method and system for displaying, communicating, collaborating and assessing an idea and its details for a more complete comprehension and/or understanding for implementing the idea. The method comprises and/or consists of the following steps.

Step 1 provides a computer including a screen for displaying a number of interactive screens or scenarios wherein each screen or scenario includes a plurality of interactive blocks.

A second step calls for displaying on the computer a basic idea and a plurality of interactive screens or scenarios wherein each screen or scenario includes a plurality of interactive blocks or chains of blocks.

In the next or third step a value chain includes blocks for outcomes, obstacles and beneficiaries. This step is entered in the computer for focusing on final outcomes that can be delivered to the beneficiaries for helping a user to think along such lines.

Then subsequent to the above, a knowledge chain includes blocks for the known, the unknown, and knowledge gaps that should be resolved for developing a better understanding of additional aspects of an idea.

In a further step, an activities/resources chain includes blocks for key activities and key resources which are entered into the computer for focusing a user or users' attention on what activities and resources are needed to deliver the outcomes to the beneficiaries.

In a preferred embodiment of the invention, the steps of writing an idea down in a first block and moving to a second block, making an entry in the second block and moving back to the previous block for modification for further modifications to the previous block or additions of a block to the previous block in view of the second block so that a user considers different bits at the same time as well as the interaction between blocks.

The invention also contemplates a system for displaying, communicating, collaborating and assessing an idea and the details of the idea for a more complete understanding of implementing the idea.

The system includes a computer and a monitor for displaying a number of interactive screens or scenarios wherein each of the screens or scenarios includes a plurality of interactive blocks or chains of blocks and an input device including a keyboard.

Means including the computer, monitor and input device for displaying an idea and a plurality of interactive screens or scenarios wherein each screen or scenario includes a plurality of blocks may be included.

In addition, the system includes a value chain including blocks for outcomes, obstacles and beneficiaries for focusing on final outcomes that can be delivered to the beneficiaries for helping a user in thinking along such lines.

Further, the system includes a knowledge chain including blocks for known, unknown and knowledge gaps that need to be resolved for developing a better understanding of the idea.

Finally, the system includes an activities-resource chain including blocks for key activities and key resources for focusing a user's attention on what activities and resources are needed to deliver the outcomes to the beneficiaries.

The invention will now be described in connection with the accompanying drawings wherein like elements are identified with like reference numbers.

### DESCRIPTION OF THE DRAWINGS

FIG. 1 is a schematic illustration of a value chain as incorporated in the present invention;

FIG. 2 is a schematic illustration of a knowledge chain as incorporated in the present invention;

FIG. 3 is a schematic illustration of an activities-resources loop as used in the invention;

FIG. 4 is a schematic illustration of the knowledge chain as illustrated in FIG. 2 but modified for a researcher or post graduate;

FIG. 5 is a schematic illustration of the value chain shown in FIG. 1 but adapted for a start-up or incubator.

FIG. 6 is a schematic illustration of a process for evaluating a first embodiment of the invention;

FIG. 7 is a schematic illustration of a process for evaluating a second embodiment of the invention; and

FIG. 8 is a flow chart for one embodiment of a computer-implemented method for evaluating an idea in accordance with the present invention.

### DESCRIPTION OF THE PREFERRED EMBODIMENT OF THE INVENTION

In general, the invention referred to as an idea canvas is a live document that can be used to communicate ideas and their details between one or more users. Therefore, it can be considered as a canvas that offers a common language for working on and collaborating on different ideas or projects.

There are a variety of uses of the idea canvas since it can help capture different perspectives or faces of different ideas or projects. This application illustrates and discusses a number of examples of where it is believed that the Idea Canvas can help. Two detailed illustrations showing the actual use of the canvas to capture and develop idea(s) and the thinking process are attached.

The idea canvas incorporates a number of blocks. Users can freely start from any block and navigate around between different blocks and visiting already used blocks until a good understanding of the main idea is reached.

With that in mind, the following are blocks that form what can be called chains because a change in one of these blocks is likely to influence other blocks within the chain or even other chains. This is the goal of using the Idea Canvas, to help in understanding the big picture and the inter-relationships between the different building blocks.

### The Value Chain

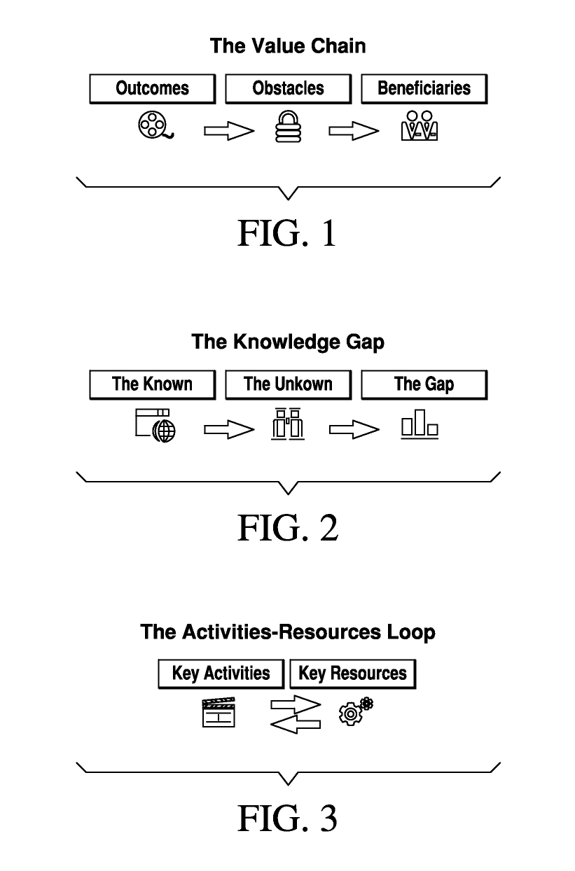

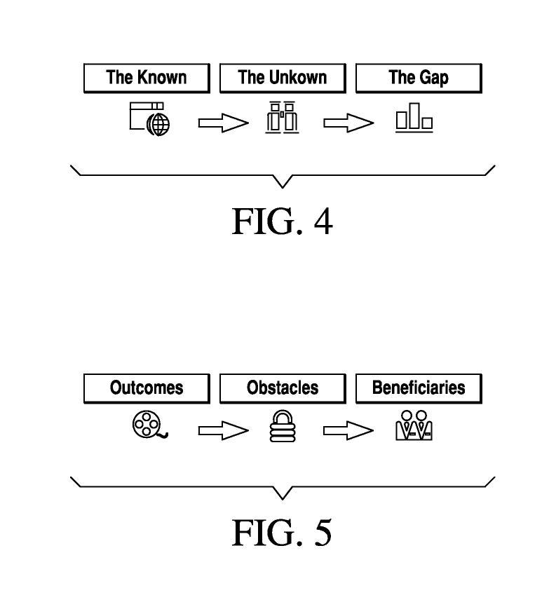

The value chain illustrated in FIG. 1 focuses on the final outcomes that can be delivered to a beneficiary or beneficiaries (stockholders, customers, etc.). This helps the user in thinking from one end to the other.

### The Knowledge Gap

As illustrated in FIG. 2, this chain focuses on the knowledge gaps that should be resolved to help develop a better understanding of certain parts or an idea(s) and project(s) as a whole. There are two main types of gaps that should be taken into account:

Development gaps: These are smaller gaps that should be resolved to help develop certain parts of the project. For instance, a gap between required and current personal technical skills indicates the need to undertake additional activities to develop the necessary skills. After such activities are taken, the gap is resolved.

Major gaps: These are gaps that significantly affect the outcomes. For instance, a company planning to produce a new product may not yet have a good understanding of materials that can be used to manufacture the product. Similarly, a startup introducing a new product or service will surely have at least one major gap as a result of uncertainties associated with startups. Relevant activities must be defined and achieved in order to reduce uncertainties.

### The Activities-Resources Loop

The focus of FIG. 3 is on the key activities and resources that are needed to deliver the outcomes. It is a loop because all key activities must have sufficient resources to carry them and all key resources must correspond to key activities.

Therefore, there are two important questions to consider.

Do you have sufficient resources to carry out the key activities?

Do all key resources correspond to key activities or do you have additional unneeded resources?

### The Process & Variety of Uses

One of the main merits of using visual idea canvases is to encourage thinking differently. The user can think and write down ideas in a block, move to another block and then move back to the first block. The use of blocks helps the user in visualizing the different bits of the main or primary idea(s), and at the same time, helps him/her think about the different bits at the same time.

There is no one correct way to follow or navigate and use of the idea canvas. However, Applicant believes that the following starting paths may help users in reaching a better understanding of the main idea(s) faster. That being said, the following demonstrates the variety of uses for the Idea Canvas.

### Researchers/Postgraduate Students

One important thing that researchers need to consider is what their contribution to knowledge is. By understanding what he/she knows and the current state of the field (The Known), the researcher can then begin to push the boundaries in an attempt to find unexplored areas of the research field as well as different things he has yet to understand (The Unknown).

By clearly defining the gaps in personal knowledge and in the field (The Gaps), the researcher can then define key activities that should be carried out to close these development gaps (leading to his/her own development) or research gaps (leading to contributions to knowledge).

### Startups, Startup Accelerators and Incubators

It is a given that products and services are developed for end-customers. Therefore, with that customer-focus in mind, starting with what could be called the value chain (Outcomes, Obstacles, Beneficiaries) and then navigating through the different blocks may yield the best results for businesses looking to use the Idea Canvas. This allows businesses to first establish whom their customers are and what outcomes, benefits, or contributions can be made to satisfy them.

### Investors

Investors can make use of the Idea Canvas to quickly reach a better understanding of the benefits a company can or may offer. They can use the Idea Canvas with CEOs or board members of companies they have invested in to easily and clearly reach a common understanding and develop the company further. A good starting point for investors or others running a company is the value chain.

### Inventors/Innovators

Not all innovators are fully aware of their inventions and how they may impact others or the market. Ultimately, inventions should be commercialized. The Idea Canvas can help inventors understand and develop their potential and a business sense in a simple way. Since commercialization is the goal, a good starting point is the value chain; to understand what outcomes can be achieved and for whom.

### IP Filing, Business Consultants and Mentors

The Idea Canvas can be used as a log, to document all aspects related to the idea(s) and to help guide the thinking process of individuals. Those individuals may not be able to think holistically and cover all aspects related to the idea(s), or, perhaps they are not fully aware of the different aspects impacting their idea(s) or lack a business sense. Not all inventors are businessmen. Therefore, they may find it difficult to think in terms of who their customers are, how they can solve their problems, how much they can be paid, and how much all of this will cost them. Also, business consultants and mentors may know more than their clients due to their vast experiences. The Idea Canvas helps those experts in guiding and developing the thinking process of others to a level where both parties can communicate and discuss effectively.

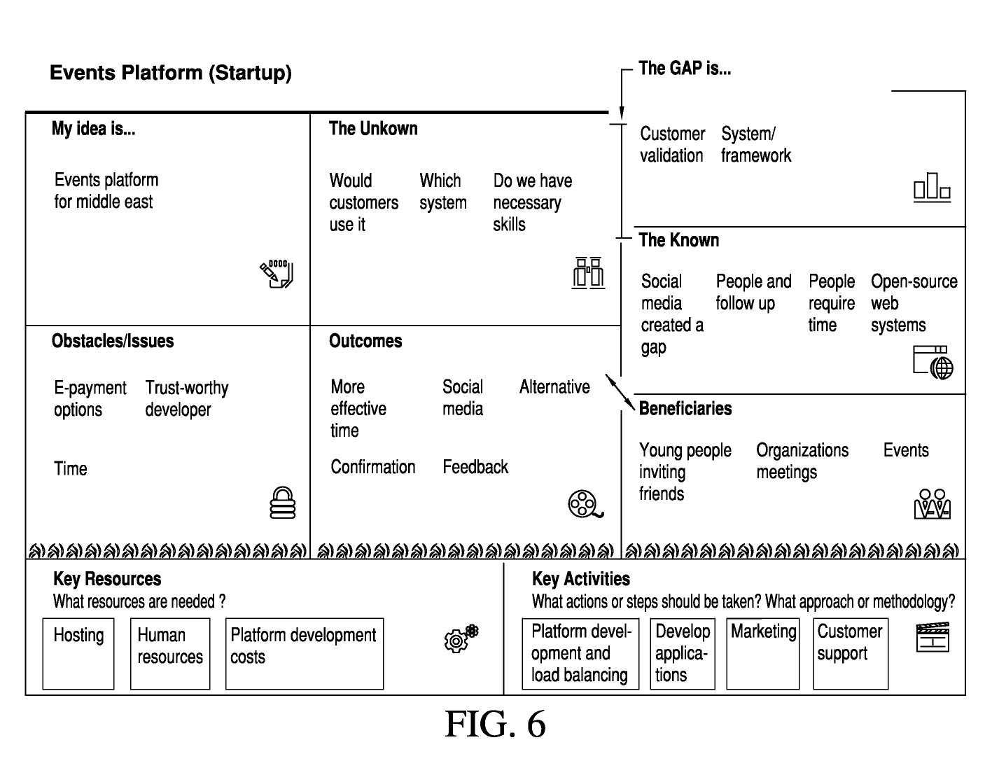

Referring to FIG. 6 which illustrates one embodiment: an Online Events Platform (Startup). If you have more than one idea or if you are comparing competing ideas a user can use different colors or post-it notes for each separate idea. To be more specific, on post-it notes can have a large letter “A” to signify an assumption that needs to be checked or investigated. Under the idea, a block is provided to record an events management platform for the Middle East. Proceeding across the diagram the unknown discloses what are the things you need to know to realize and/or utilize your idea. For example, you need to understand regulations and need to research existing literature on the topic of the idea. The blocks then include will customers like it or use it in their daily life plus a second block for an open source system to use and which plug-ins. A third block might ask, do you have the necessary skills to develop it fully or do you need additional developers. Proceeding across the figure, you have a gap which is a clearly defined gap in knowledge between what you know and what you need to know. Add relevant activities to help you close the gap. For example find the gap in knowledge that could contribute to learn more about the model and can be applied to the best way to market products or services.

The first block below the gap refers to customer validation to ensure product fit. A second block includes figuring out which system framework to use. Below that the known, that is what is currently known about the idea. There is a need for X low quality alternatives of why exist. The blocks under this heading include social media created a gap between people. The second block is it is very difficult to invite a lot of people and follow up for confirmation. A third block involves inviting many people. This requires time and considerable effort. A final block provides an open-source web systems that can be used as a base framework. Below that the beneficiaries are identified. That is who will benefit from your ideas and who would be interested in seeing you succeed.

Consider for example, investors, sponsors and customers. Further examples are shown in the following three blocks. First young people inviting their friends to go out for meetings. The second block is organizations running meetings or official events while a third identifies events and venues with places to meet.

In a second row you can identify obstacles/issues, what difficulties do you foresee in fulfilling your idea. Examples, finding sponsors or investors, approvals, and resistance. The blocks include epayment options which may be limited in the area going across the row, finding a trustworthy developer to add to the team. Below that is recognition for the time due to the size of your team.

Under outcomes, what are the benefits, outcomes or contributions expected? Does product X contribute to research fields that may result in better quality of X. The blocks in this area indicate more effective and less effort and time consuming ways. In addition, taking advantage of social media and being able to invite people are considered. A third block in the row is to identify lower cost alternatives to wedding invitations and similar things. Below those but in the same block are early confirmation allows host to prepare properly (food etc.) and another block an ability to receive feedback from the events past.

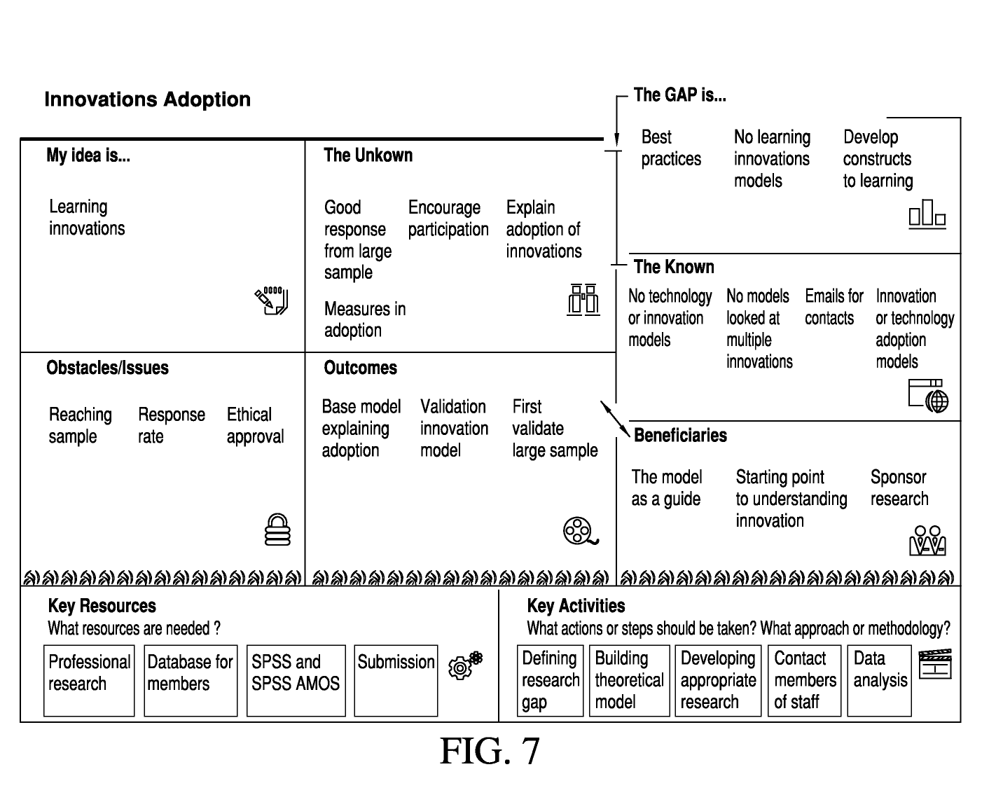

Finally, below the three columns the system identifies key resources. What resources are needed. The first block is hosting, servers and maintenance. A second block refers to human resources and a third block is a platform for development and maintenance cost. On the other side of the figures, key activities are identified in the blocks 1, 2, 3 and 4. What actions or steps should be taken, what approach or methodology and what key resources are needed. Under key activities what actions or steps should be taken, what approach or methodology, for example, research existing solutions, discuss proposals directions, proposed solutions or data collection. The first block refers to platform development and ongoing maintenance and load balancing. The second block refers to developing mobile applications while the third block refers to marketing and social member programs. Finally, a fourth block indicates customer support. After reviewing an overall picture presented by the idea canvas, consider FIG. 7.

As illustrated in FIG. 7, an innovation adoption model identifies an embodiment for learning an innovation adoption model (PhD Research). If you have more than one idea or if you are comparing competing ideas, use a different color pen or post-it notes for each. The first step is developing and validating a learning innovation adoption model for use in education. Then, under the Unknown, what are the things you need to know to utilize your idea. First, will you get a good response from a large sample, second how to encourage participation in an online questionnaire and a third block for how well will the model explain the adoption of learning innovations. Finally a fourth block is will student related measures help in explaining adoption better in universities?

Moving across the figure, under the Gap define the gap in knowledge between what you know and what you need to know and add relevant activities to help you close the gap. Then under that, there are three blocks which are 1. to find and follow best practices to ensure higher email response rate. In a second block, there are no learning innovations adoption models to help explain adoption in unis (inventors please what is unis) and the third block includes develop constructs related to students learning and requirements. Under the gap are The Known, for example, what is currently known about the idea and realizing it. Examples, is there a need for X as a low quality alternatives to Y.

Then there are four blocks under The Known. In a first block, technology or innovation adoption models that look at education related factors. In the second block, no other models looked at multiple innovations at the same time. A third block refers to emails for contacts that can be collected from university websites, and a final block refers to innovation or technology adoption models that did not look at student related measures.

Below the know is a reference to Beneficiaries, who will benefit from the idea, who would be interested in seeing you succeed. Examples, inventors, sponsors and customers. Under Beneficiaries there are three blocks including a first block universities can use the model as a guide to build it, a second block includes researchers that can use it as a starting point to understand innovation adoption. Finally, a sponsor may demand research and publications.

Below the idea, the unknown, obstacles and issues are identified. What difficulties do you foresee in fulfilling your idea. Examples, finding sponsors or investors, approvals, resistance. The following blocks are indicated. The first block identifies reaching a large sample, while the second block indicates getting a good response rate. Finally, a third block indicates getting ethical approval to collect from a large sample. Outcomes cover a group of blocks to identify what are the benefits, outcomes or contributions expected? Examples, product X, contribution to research field, better quality of X. The first block identifies a base model explaining adoption of learning innovations, while a second block identifies validation of an innovation model using multiple innovations. A third block includes a first study that aims to validate a model using a large sample.

Key resources identify what resources may be used. Examples include money, time, human resources, and tools. The following blocks include access to professional research suite, a database for over 17,000 members of staff within UK universities, SPSS and SPSS AMOS (an example of software packages that may be used) for analysis of the data.

Key activities are in a lower right side of the figure to identify What activities or steps may be taken. What approach or methodology? For example, research existing solutions, discuss proposed solution with X and data collection. Defining the research gap and research questions, building a theoretical model, developing the appropriate research approach to validate it, collect and contact members of staff across UK universities and data analysis.

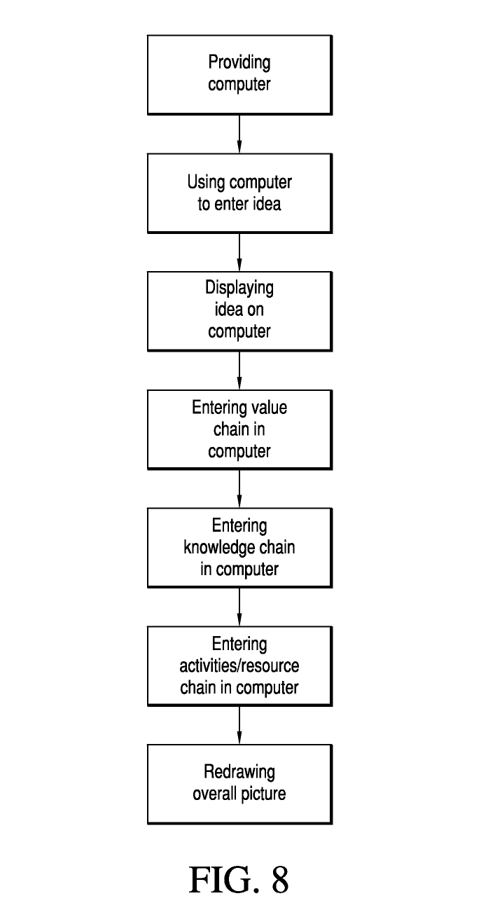

Finally, FIG. 8 illustrates a flowchart for one embodiment of the invention. For example, step 1 provides a computer 20, step 2 using the computer to enter the idea 22 that is followed by step 3 displaying the idea 24 on one or more computers. The fourth step 26 involves entering a value chain in a computer or multiple computers followed by step 5 entering a knowledge chain in the computer 28. This is followed by step 6 of entering the activities-resources chain in the computer 30 and finally step 7 reviewing overall picture 32.

While the invention has been described in connection with the preferred embodiments it should be recognized that changes and modifications may be made therein without departing from the scope of the appended claims.

What is claimed is:

1. A computer-implemented method for displaying, communicating, collaborating and assessing an idea and its details for a more complete understanding of an implementation of the idea, said method comprising:
providing a computer and monitor for displaying a number of interactive screens or scenarios wherein each screen or scenario includes a plurality of interactive blocks or chains;
displaying by the computer an idea and a plurality of interactive screens or scenarios wherein each screen or scenario includes a plurality of interactive blocks or chains of blocks; and
wherein the following chains of blocks are entered into said computer;
entering a value chain including blocks for outcomes, obstacles and beneficiaries for focusing on a final outcome that can be delivered to the beneficiaries for helping a user in thinking along such lines;
a knowledge chain including blocks for the known, the unknown and knowledge gaps that should be resolved for developing a better understanding of certain parts of the idea; and
an activities resources chain including blocks for key activities and key resources for focusing a user's attention on what activities and resources are needed to deliver the outcomes to the beneficiaries.

2. The computer-implemented method for displaying, communicating, collaborating and assessing an idea and its details for a more complete understanding of an implementation of the idea according to claim 1, which includes the steps of writing ideas down in a block moving to another block and then moving back to a previous block to a user to think of the different bits at the same time as well as the interaction between blocks.

3. The computer-implemented method for displaying, communicating, collaborating and assessing an idea and its details for a more complete understanding of an implementation of the idea according to claim 1, wherein a researcher or post graduate student needs to consider in what their contribution to knowledge will be, to do so, a user by understanding what he or she knows and the current state of the field, the knowns, the user can push at the boundaries to find unexplored areas of a research field as well as different things that they have yet to understand.

4. The computer-implemented method for displaying, communicating, collaborating and assessing an idea and its details for a more complete understanding of an implementation of the idea according to claim 1, in which the idea relates to a startup, a startup acceleration or incubation and wherein the value chain is focused on the customer and navigating through the different blocks yields the best results and allows a business to establish whom their customers are and what outcomes, benefits or contributions can be made to satisfy them.

5. The computer-implemented method for displaying, communicating, collaborating and assessing an idea and its details for a more complete understanding of an implementation of the idea according to claim 1, in which the idea relates to investments and to use the value chain to reach a common understanding and developing a company further.

6. The computer-implemented method for displaying, communicating, collaborating and assessing an idea and its details for a more complete understanding of an implementation of the idea according to claim 1, in which the idea relates to inventions and innovations and the use of the value chain to focus on the commercial potential and what outcomes can be achieved and for whom.

7. A computer-implemented method for displaying, communicating, collaborating and assessing an idea and its details for a more complete understanding of an implementation of the idea, said method comprising:
establishing a network of linked computers each with a monitor for a plurality of users to develop a better understanding in pursuing an idea and for displaying a number of interactive screens and scenarios wherein each scene and scenario include a plurality of interactive blocks or chains;
displaying on each of said computers a basic idea and a plurality of interactive screens or scenarios wherein each screen or scenario includes a plurality of interactive blocks for chains of blocks; and
wherein the following chains of blocks are entered into said computer and displayed;
a value chain includes blocks for outcomes, obstacles and beneficiaries for focusing on final outcomes that can be delivered to the beneficiaries for helping a user in thinking along those lines;
a knowledge chain including blocks for the known, the unknown and knowledge gaps that should be resolved to develop a better understanding of certain parts of the idea; and
an activities-resources chain including blocks for key activities and key resources for focusing a user's attention on what activities and resources are needed to deliver the outcomes to the beneficiaries.

8. A computer-implemented method for displaying, communicating, collaborating and assessing an idea and its details for a more complete understanding of an implementation of the idea, said method consisting of:
providing a computer and monitor for displaying a number of interactive screens and scenarios wherein each screen or scenario includes a plurality of interactive blocks or chains;
displaying by the computer an idea and a plurality of interactive screens and scenarios wherein each screen and scenario includes a plurality of interactive blocks or chains or chains of blocks; and
wherein the following chains of blocks are entered into said computer;
entering a value chain including blocks for outcomes, obstacles and beneficiaries for focusing on a final outcome that can be delivered to the beneficiaries for helping a user in thinking along such lines;
a knowledge chain including blocks for the known, the unknown and knowledge gaps that should be resolved for developing a better understanding of certain parts of the idea; and
an activities resources chain including blocks for key activities and key resources for focusing a user's attention on what activities and resources are needed to deliver the outcomes to the beneficiaries.

9. A computer-implemented method for displaying, communicating, collaborating and assessing an idea and its details for a more complete understanding of an implementation of the idea, said method consisting of:
establishing a network of linked computers each with a monitor for a plurality of users to develop a better understanding in pursuing an idea and for displaying a number of interactive screens and scenarios wherein each scene and scenario include a plurality of interactive blocks or chains;
displaying on each of said computers a basic idea and a plurality of interactive screens or scenarios wherein each screen or scenario includes a plurality of interactive blocks for chains of blocks; and
wherein the following chains of blocks are entered into said computer and displayed;
a value chain includes blocks for outcomes, obstacles and beneficiaries for focusing on final outcomes that can be delivered to the beneficiaries for helping a user in thinking along those lines;
a knowledge chain including blocks for the known, the unknown and knowledge gaps that should be resolved to develop a better understanding of certain parts of the idea; and
an activities-resources chain including blocks for key activities and key resources for focusing a user's attention on what activities and resources are needed to deliver the outcomes to the beneficiaries.

10. A system for displaying, communicating, collaborating and assessing an idea and the details of the idea for a more complete understanding of implementing the idea, said system comprising:
a computer including a monitor for displaying a number of interactive screens and/or scenarios wherein each screen and/or scenario include a plurality of interactive blocks or chains of blocks; and
means including the computer and monitor plus an input device for displaying an idea and a plurality of interactive screens and/or scenarios wherein each screen and/or scenario include a plurality of interactive blocks or chains of blocks;
a value chain including blocks for outcomes, obstacles and beneficiaries for focusing on final outcomes that can be delivered to the beneficiaries for helping a user in thinking along those lines;
a knowledge chain including blocks for the known, the unknown and knowledge gaps that need to be resolved for developing a better understanding of the idea; and
an activities-resources chain including blocks for key activities and key resources for focusing a user's attention on what activities and resources are needed to deliver the outcomes to the beneficiaries.

11. A system for displaying, communicating, collaborating and assessing an idea and the details of the idea for a more complete understanding of implementing the idea according to claim 10, which includes a network of linked computers each of which includes a monitor for a plurality of users to develop an understanding in pursuing an idea.

12. A system for displaying, communicating, collaborating and assessing an idea and the details of the idea for a more complete understanding of implementing the idea, said system consisting of:
a computer including a monitor for displaying a number of interactive screens and/or scenarios wherein each screen and/or scenario include a plurality of interactive blocks or chains of blocks; and
means including the computer and monitor plus an input device for displaying an idea and a plurality of interactive screens and/or scenarios wherein each screen and/or scenario include a plurality of interactive blocks or chains of blocks;
a value chain including blocks for outcomes, obstacles and beneficiaries for focusing on final outcomes that can be delivered to the beneficiaries for helping a user in thinking along those lines;
a knowledge chain including blocks for the known, the unknown and knowledge gaps that need to be resolved for developing a better understanding of the idea; and
an activities-resources chain including blocks for key activities and key resources for focusing a user's attention on what activities and resources are needed to deliver the outcomes to the beneficiaries.
